(19) United States
(12) Patent Application Publication
(10) Pub. No.: US 2025/0287362 A1
(43) Pub. Date: Sep. 11, 2025

(54) BANDWIDTH PART FOR SENSING FUNCTIONS OF A CELLULAR WIRELESS DEVICE

(71) Applicant: QUALCOMM Incorporated, San Diego, CA (US)

(72) Inventors: Weimin DUAN, San Diego, CA (US); Hyojin LEE, San Diego, CA (US)

(21) Appl. No.: 18/597,118

(22) Filed: Mar. 6, 2024

(51) Int. Cl. H04W 72/0453; H04L 5/00

(52) U.S. Cl. CPC H04W 72/0453; H04L 5/0007

(57) ABSTRACT

A method performed by a user equipment (UE) can include transmitting, to a configuring node, capability information that includes a radio frequency (RF) bandwidth supported by the UE for sensing functions, and receiving from the configuring node, configuration information in the form of a message indicating allocation of a first RF bandwidth part (BWP) to the UE by the configuring node. The UE may utilize the first RF BWP for performing sensing functions. Another method performed by a configuring node can include receiving, from a UE, capability information that includes an RF bandwidth supported by the UE for sensing functions. The configuring node may allocate to the UE, a first RF BWP that can be based on the RF bandwidth supported by the UE for sensing functions, and may transmit to the user equipment, information about the first RF BWP.

### BACKGROUND

### 1. Field of Disclosure

The present disclosure relates generally to the field of radio frequency (RF) sensing, and more specifically to RF sensing in a wireless network.

### 2. Description of Related Art

The performance of RF sensing by wireless devices can have a wide range of consumer, industrial, commercial, and other applications. RF sensing can be used to determine the presence of a target object, determine the location of the target object, and/or track the movement of the target object over time. Cellular networks (e.g., fifth-generation (5G) new radio (NR) networks) and other types of wireless networks may be capable of performing RF sensing using base stations, user equipment (UEs), and/or other wireless devices communicatively coupled with the cellular network as “sensing nodes.” Configuring a wireless device to perform RF sensing operations can involve ensuring inter-operability of the wireless devices with one or more other devices that can be a part of the cellular network.

### BRIEF SUMMARY

Particular aspects of the subject matter described in this disclosure can be implemented to realize one or more of the following potential advantages. One potential advantage pertains to enabling a user device to perform high-resolution sensing operations based on an RF BWP that is larger than a BWP used by the user device for communications. More particularly, in an example implementation, a user device can use a low-speed analog-to-digital converter (ADC) for analog-to-digital conversion of a narrowband demodulated signal that is derived from a reflected wideband RF signal during a high-resolution sensing operation using an RF BWP. The use of a low-speed ADC having a low sampling rate provides various advantages in accordance with the disclosure, such as, for example, advantages associated with costs, complexity, and power consumption. Thus, allocation of an RF BWP based on a user device's capability to perform high resolution sensing allows optimizing of the user device's sensing capabilities without sacrificing other capabilities.

Particular aspects of the subject matter described in this disclosure include an example method performed by a user equipment to configure the user equipment for sensing functions, can include transmitting, to a configuring node, capability information comprising a radio frequency (RF) bandwidth supported by the user equipment for sensing functions; receiving, from the configuring node, configuration information comprising a message indicating allocation of a first RF bandwidth part (BWP) to the user equipment by the configuring node; and utilizing the first RF BWP for performing sensing functions.

An additional aspect of the subject matter described in this disclosure includes an example method performed by a configuring node to support a user equipment for performing sensing functions, can include receiving, from the user equipment, capability information comprising a radio frequency (RF) bandwidth supported by the user equipment for sensing functions; allocating, to the user equipment, a first RF bandwidth part (BWP) that is based, at least in part, on the RF bandwidth supported by the user equipment for sensing functions; and transmitting, to the user equipment, information about the first RF BWP allocated to the user equipment.

An additional aspect of the subject matter described in this disclosure includes an example user equipment that performs sensing functions can include at least one memory and one or more processors communicatively coupled with the memory/memories. The one or more processors are configured to transmit, to a configuring node, capability information comprising a radio frequency (RF) bandwidth supported by the user equipment for sensing functions; receive, from the configuring node, configuration information comprising a message indicating allocation of a first RF bandwidth part (BWP) to the user equipment by the configuring node; and utilize the first RF BWP for performing sensing functions.

An additional aspect of the subject matter described in this disclosure includes an example configuring node that supports a user equipment for performing sensing functions can include at least one memory and one or more processors communicatively coupled with the memory/memories. The one or more processors are configured to receive, from the user equipment, capability information comprising a radio frequency (RF) bandwidth supported by the user equipment for sensing functions; allocate, to the user equipment, a first RF bandwidth part (BWP) that is based, at least in part, on the RF bandwidth supported by the user equipment for sensing functions; and transmit, to the user equipment, information about the first RF BWP allocated to the user equipment.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified illustration of a positioning/sensing system, according to an embodiment.

FIG. 2 is a diagram of a fifth-generation (5G) new radio (NR) positioning/sensing system, according to an embodiment.

FIG. 3 is a diagram showing an example of a radio frequency (RF) sensing system.

FIG. 4 is a diagram showing some example functional elements of a UE, according to an embodiment.

FIG. 5 is a flow diagram showing information exchange between a UE and a configuring node to enable the UE to utilize an RF BWP in accordance with an embodiment of the disclosure.

FIG. 6 is a flow diagram showing information exchange between a UE and a configuring node to enable the UE to utilize an RF BWP in accordance with another embodiment of the disclosure.

FIG. 7 shows a table that includes some types of switching delays associated with some example operations performed in accordance with the disclosure.

FIG. 8 shows a table that includes some example parameters that can be associated with frequency modulated continuous wave (FMCW) operations in accordance with the disclosure.

FIG. 9 shows a flowchart of a method performed by a user equipment for executing sensing functions in accordance with the disclosure.

FIG. 10 shows a flowchart of a method performed by a configuring node to support a user equipment for performing sensing functions in accordance with the disclosure.

FIG. 11 shows a block diagram of a user equipment in accordance an embodiment of the disclosure.

FIG. 12 is a block diagram of a network node in accordance an embodiment of the disclosure.

FIG. 13 is a block diagram of an embodiment of a computer system, which may be used, in whole or in part, to provide the functions of one or more components and/or devices as described in the embodiments herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3, etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

As used herein, the terms “RF sensing,” “passive RF sensing,” and variants refer to a process by which one or more objects are detected using RF signals transmitted by a transmitting device and, after reflecting from the one or more objects, received by a receiving device. In a monostatic configuration, the transmitting and receiving devices are the same device. In a bistatic configuration, one device transmits RF signals, and another device receives reflections of the RF signals from one or more objects. In multi-static configuration, one or more receiving devices are separate from one or more transmitting devices. As used herein, the term “static” in the terms “monostatic,” “bistatic,” and “multistatic” (or “multi-static”) are meant to conform with historical literature on RF sensing but are not limited to “static” or stationary sensing nodes. As described herein, in some embodiments, sensing nodes may be mobile. As described herein, devices performing RF sensing may be referred to as “RF sensing nodes” or simply “sensing nodes.” In a bistatic or multi-static configuration, transmitting devices may be referred to as “transmitting nodes,” “Tx sensing nodes,” or “Tx nodes,” and receiving devices may be referred to as “receiving nodes,” “Rx sensing nodes,” or “Rx nodes.” As described hereafter in more detail, a receiving device can make measurements of these reflected RF signals to determine one or more characteristics of the one or more objects, such as location, range, angle, direction, orientation, Doppler, velocity, etc. According to some embodiments, RF sensing may be “passive” in that no RF signals need to be transmitted by the receiving device or one or more objects for the one or more objects to be detected.

Additionally, unless otherwise specified, references to “reference signals” and the like may be used to refer to signals used for positioning of a user equipment (UE), sensing of active and/or passive objects by one or more sensing nodes, or a combination thereof. As described in more detail herein, such signals may comprise any of a variety of signal types. This may include but is not limited to, a positioning reference signal (PRS), sounding reference signal (SRS), synchronization signal block (SSB), channel start information reference signal (CSI-RS), or any combination thereof.

Techniques provided herein may apply to “mmWave” technologies, which typically operate at 57-71 GHz, but may include frequencies ranging from 30-300 GHz. This includes, for example, frequencies utilized by the 802.11ad Wi-Fi standard (operating at 60 GHZ). That said, some embodiments may utilize RF sensing with frequencies outside this range. For example, in some embodiments, 5G NR frequency bands (e.g., 28 GHZ) may be used. Because RF sensing may be performed in the same bands as communication, hardware may be utilized for both communication and RF sensing. For example, one or more of the components of an RF sensing system as described herein may be included in a wireless modem (e.g., Wi-Fi or NR modem), a UE (e.g., an extended device), or the like. Additionally, techniques may apply to RF signals comprising any of a variety of pulse types, including compressed pulses (e.g., comprising Chirp, Golay, Barker, or Ipatov sequences) may be utilized. That said, embodiments are not limited to such frequencies and/or pulse types. Additionally, because the RF sensing system may be capable of sending RF signals for communication (e.g., using 802.11 or NR wireless technology), embodiments may leverage channel estimation and/or other communication-related functions for providing RF sensing functionality as described herein. Accordingly, the pulses may be the same as those used in at least some aspects of wireless communication.

As noted, RF sensing may be performed by wireless devices or sensing nodes and can have a wide range of consumer, industrial, commercial, and other applications. As also noted, RF sensing may be performed in the same bands used for communication purposes and a wireless device (referred to henceforth as a user device) can include hardware and software that may be utilized for both communication and RF sensing. In an example operating environment, the user device may be constrained to operate within an assigned band of frequencies that is generally referred to herein as a bandwidth part (BWP). The use of BWPs may generally be directed at two aspects. A first aspect is bandwidth adaptation to help reduce device power consumption in a user device and a second aspect is to provide support for devices that utilize various bandwidths. More particularly, a user device may use a wide bandwidth when operating upon a large amount of data over some periods of time and may use a smaller bandwidth at some other periods of time. Power consumption may be reduced by allocating two different BWPs for use by the user device during these two periods of time. The BWP allocation can be carried out by a base station based on factors such as, for example, a channel bandwidth made available to the base station for BWP assignments and a number of user devices supported by the base station.

However, BWP allocation practices may fail to take into consideration differences between the capabilities of various types of user devices to perform various types of sensing functions. For example, a first user device may have a capability to perform high resolution sensing operations using wideband RF signals. A second user device may have a limited capability to perform sensing operations and may consequently use a narrower RF band. Allocating an identical BWP to both user devices for performing sensing functions can therefore be a sub-optimal approach. Embodiments described herein address this aspect and other aspects based on the use of BWPs that can be flexibly allocated to various user devices based on individual capabilities of the user devices to perform sensing operations.

Furthermore, BWP allocation practices may also fail to take into consideration a capability of a user device for performing RF sensing functions in conjunction with communication functions. For example, a user device capable of only narrowband communications using a relatively small BWP may also be capable of high-resolution sensing using a relatively large BWP. Thus, in an example embodiment, a user device may be allocated an RF BWP for RF sensing that is larger than a baseband BWP used by the user device for communication operations. The user device can perform a high-resolution sensing operation based on use of the allocated RF BWP either jointly while performing communication functions, or in an independent mode of operation when not performing communication operations.

Particular aspects of the subject matter described in this disclosure can be implemented to realize one or more of the following potential advantages. A first potential advantage can be associated with a method that can be used to configure a user device to utilize, what is referred to herein as an “RF BWP.” A request made by the user device to a configuring node (such as, for example, a base station) for allocation of the RF BWP may be based on the capabilities of the user device for performing sensing operations. In an example implementation, the user device may utilize the RF BWP for performing sensing operations at some times and may utilize what is referred to herein as a “baseband BWP” for communication purposes at some other times. The RF BWP is typically larger than the baseband BWP. A discussion of embodiments is provided below after a brief discussion of relevant technology and context/background in which embodiments may be used. It must be understood that the labels “sensing function” and “sensing function” are used herein in an interchangeable manner.

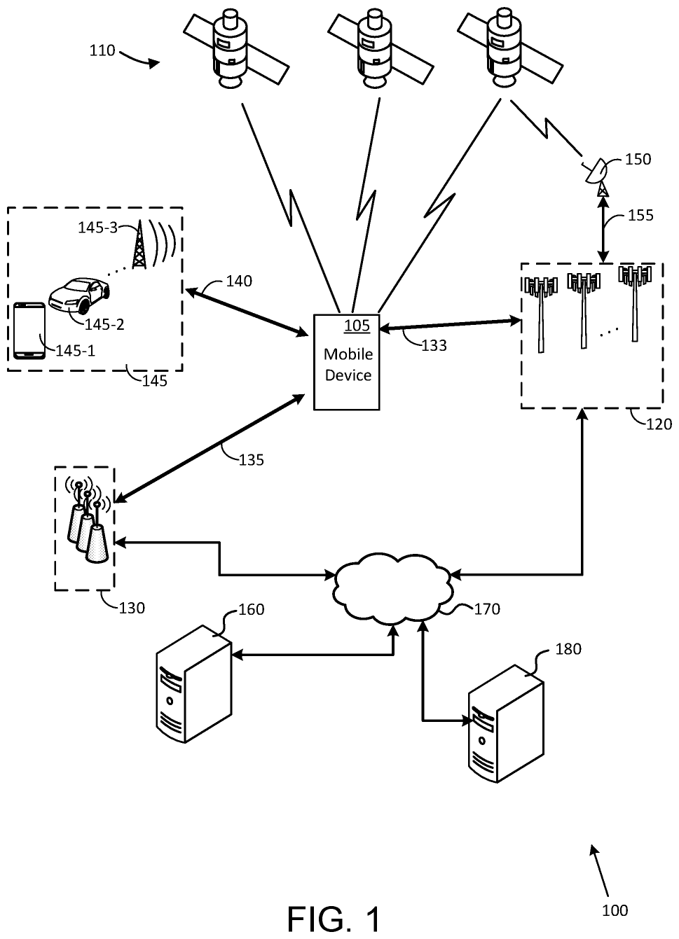

FIG. 1 is a simplified illustration of a positioning/sensing system 100, which may be implemented in conjunction with and/or as part of a wireless communication system (e.g., cellular communication network) which includes a mobile device 105, location/sensing server 160, and/or other components of the positioning/sensing system 100 can use the techniques provided herein for requesting and obtaining support for an RF signal that can be used by the mobile device 105 for sensing purposes according to an embodiment. The techniques described herein may be implemented by one or more components of the positioning/sensing system 100, however the techniques described herein are not limited to such components and may be implemented in other types of systems (not shown). The positioning/sensing system 100 can include: the mobile device 105; one or more satellites 110 (also referred to as space vehicles (SVs)) for a Global Navigation Satellite System (GNSS) (such as the Global Positioning System (GPS), GLONASS, Galileo or Beidou) and/or Non-Terrestrial Network (NTN) functionality; base stations 120; access points (APs) 130; location/sensing server 160; network 170; and external client 180. Generally put, the positioning/sensing system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or to perform RF sensing (e.g., of one or more objects by using RF signals transmitted by one or more wireless devices).

It should be noted that FIG. 1 provides only a generalized illustration of various components, any or all of which may be utilized as appropriate, and each of which may be duplicated, as necessary. Specifically, although only one mobile device 105 is illustrated, it will be understood that many UEs (e.g., hundreds, thousands, millions, etc.) may utilize the positioning/sensing system 100. Similarly, the positioning/sensing system 100 may include a larger or smaller number of base stations 120 and/or APs 130 than illustrated in FIG. 1. The illustrated connections that connect the various components in the positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location/sensing server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G, and NR are wireless technologies defined, or being defined, by the 3rd Generation Partnership Project (3GPP). In an LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base stations 120 may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), a New Radio (NR) NodeB, a Next Generation Node B (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components.

An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location/sensing server 160, by accessing the network 170 via a base station 120 using a first communication link 133. Additionally or alternatively, because APs 130 also may be communicatively coupled with the network 170, mobile device 105 may communicate with network-connected and Internet-connected devices, including location/sensing server 160, using a second communication link 135, or via one or more other mobile devices 145. As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” used herein may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the mobile device 105 to communicate with the network 170 via satellites 110, but this can also enable network-based positioning, RF sensing, etc.

Satellites 110 may be utilized in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server that may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

As used herein, the term “cell” may generically refer to a logical communication entity used for communication with a base station 120 and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location/sensing server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location/sensing server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location/sensing server 160. In some embodiments, the location/sensing server 160 may comprise, a Discovered SLP (D-SLP) or an Emergency SLP (E-SLP). The location/sensing server 160 may also comprise an Enhanced Serving Mobile Location Center (E-SMLC) that supports location of mobile device 105 using a control plane (CP) location solution for LTE radio access by mobile device 105. The location/sensing server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location/sensing server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning/sensing system 100 (e.g., satellites 110, APs 130, base stations 120). The estimated location of the mobile device 105 can be estimated geometrically (e.g., using multiangulation and/or multilateration), based on the distance (range) and/or angle measurements, along with known position of the one or more components.

Additionally or alternatively, the location/sensing server 160, may function as a sensing server. A sensing server can be used to coordinate and/or assist in the coordination of sensing of one or more objects (also referred to herein as “targets”) by one or more wireless devices in the positioning/sensing system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF or SnMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra-Wideband (UWB), IEEE 802.15x, or a combination thereof. Mobile devices 145 may additionally or alternatively use non-RF wireless signals for positioning of the mobile device 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular mobile device 105, the mobile device 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate,” “estimated location,” “location,” “position,” “position estimate,” “position fix,” “estimated position,” “location fix” or “fix.” The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

As previously noted, the example positioning/sensing system 100 can be implemented using a wireless communication network, such as an LTE-based or 5G NR-based network, or a future 6G network.

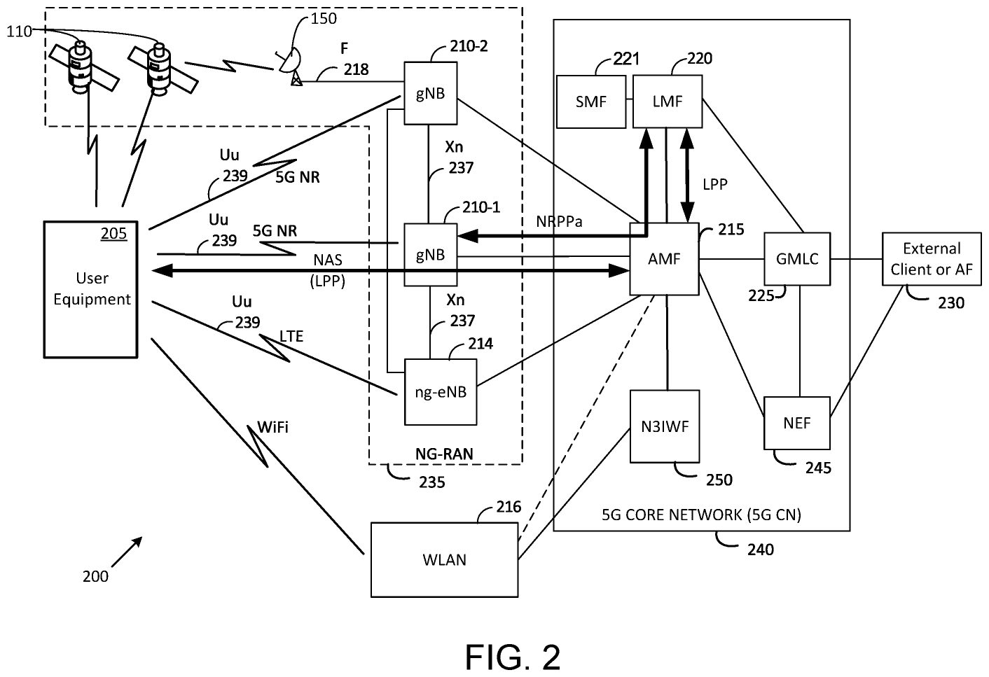

FIG. 2 shows a diagram of a 5G NR positioning/sensing system 200, illustrating an embodiment of a positioning/sensing system (e.g., positioning/sensing system 100) implemented in 5G NR. The 5G NR positioning/sensing system 200 may be configured to enable wireless communication, determine the location of a UE 205 (which may correspond to the mobile device 105 of FIG. 1), perform RF sensing, or a combination thereof, by using access nodes, which may include NR NodeB (gNB) 210-1 and 210-2 (collectively and generically referred to herein as gNBs 210), ng-eNB 214, and/or WLAN 216 to implement one or more positioning methods. These access nodes can use RF signaling to enable the communication, implement one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR positioning/sensing system 200 additionally may be configured to determine the location of a UE 205 by using an LMF 220 (which may correspond with location/sensing server 160) to implement the one or more positioning methods. The SMF 221 may coordinate RF sensing by the 5G NR positioning/sensing system 200. Here, the 5G NR positioning/sensing system 200 comprises a UE 205, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. Additional components of the 5G NR positioning/sensing system 200 are described below. The 5G NR positioning/sensing system 200 may include additional or alternative components.

The 5G NR positioning/sensing system 200 may further utilize information from satellites 110. As previously indicated, satellites 110 may comprise GNSS satellites from a GNSS system like Global Positioning/sensing system (GPS) or similar system (e.g. GLONASS, Galileo, Beidou, Indian Regional Navigational Satellite System (IRNSS)). Additionally or alternatively, satellites 110 may comprise NTN satellites. NTN satellites may be in low earth orbit (LEO), medium earth orbit (MEO), geostationary earth orbit (GEO) or some other type of orbit. NTN satellites may be communicatively coupled with the LMF 220 and may operatively function as a TRP (or TP) in the NG-RAN 235. As such, satellites 110 may be in communication with one or more gNBs 210 via one or more NTN gateways 150. According to some embodiments, an NTN gateway 150 may operate as a DU of a gNB 210, in which case communications between NTN gateway 150 and CU of the gNB 210 may occur over an F interface 218 between DU and CU.

It should be noted that FIG. 2 provides only a generalized illustration of various components, any or all of which may be utilized as appropriate, and each of which may be duplicated or omitted, as necessary. Specifically, although only one UE 205 is illustrated, it will be understood that many UEs (e.g., hundreds, thousands, millions, etc.) may utilize the 5G NR positioning/sensing system 200. Similarly, the 5G NR positioning/sensing system 200 may include a larger (or smaller) number of satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning/sensing system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High-Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning/sensing system 200, such as the LMF 220 and AMF 215.

5G NR positioning/sensing system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations, and may also include NTN satellites 110. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214, WLAN 216, or NTN satellite 110.

In some embodiments, an access node, such as a gNB 210, ng-eNB 214, WLAN 216, or NTN satellite 110, or a combination thereof, (alone or in combination with other components of the 5G NR positioning/sensing system 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, WLAN 216, and NTN satellite 110) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, WLAN 216, or NTN satellite 110) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a location of the UE 205) may be performed at the UE 205 (e.g., by measuring downlink PRS (DL-PRS) signals transmitted by wireless nodes such as gNB 210, ng-eNB 214, WLAN 216, or NTN satellite 110, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable the secure provision of information from the external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE-based position methods such as A-GNSS, RTK, TDOA, multi-cell RTT, AoD, and/or ECID. The NRPPa protocol may be used to support positioning of UE 205 using network-based position methods such as ECID, AoA, uplink TDOA (UL-TDOA) and/or may be used by LMF 220 to obtain location-related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location-related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE-assisted or UE-based positioning of UE 205 by LMF 220.

In a 5G NR positioning/sensing system 200, positioning and sensing methods can be categorized as being “UE assisted” or “UE based.” This may depend on where the request for determining the position of the UE 205 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 205 may obtain location measurements and send the measurements to a location server (e.g., LMF 220) for computation of a location estimate for UE 205. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), RSTD, Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 205 if the positions of the other UEs are known. The location measurements may also or instead include measurements for RAT-independent positioning methods such as GNSS (e.g., GNSS pseudorange, GNSS code phase, and/or GNSS carrier phase for GNSS satellites), WLAN, etc.

With a UE-based position method, UE 205 may obtain location measurements (e.g., which may be the same as or similar to location measurements for a UE-assisted position method) and may further compute a location of UE 205 (e.g., with the help of assistance data received from a location server such as LMF 220, an SLP, or broadcast by gNBs 210, ng-eNB 214, or WLAN 216).

With a network-based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 205, and/or may receive measurements obtained by UE 205 or by an AP in WLAN 216 in the case of N3IWF 250, and may send the measurements to a location server (e.g., LMF 220) for computation of a location estimate for UE 205.

Positioning of the UE 205 also may be categorized as UL, DL, or DL-UL based, depending on the types of signals used for positioning. If, for example, positioning is based solely on signals received at the UE 205 (e.g., from a base station or other UE), the positioning may be categorized as DL based. On the other hand, if positioning is based solely on signals transmitted by the UE 205 (which may be received by a base station or other UE, for example), the positioning may be categorized as UL based. Positioning that is DL-UL based includes positioning, such as RTT-based positioning, which is based on signals that are both transmitted and received by the UE 205. Sidelink (SL)-assisted positioning comprises signals communicated between the UE 205 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

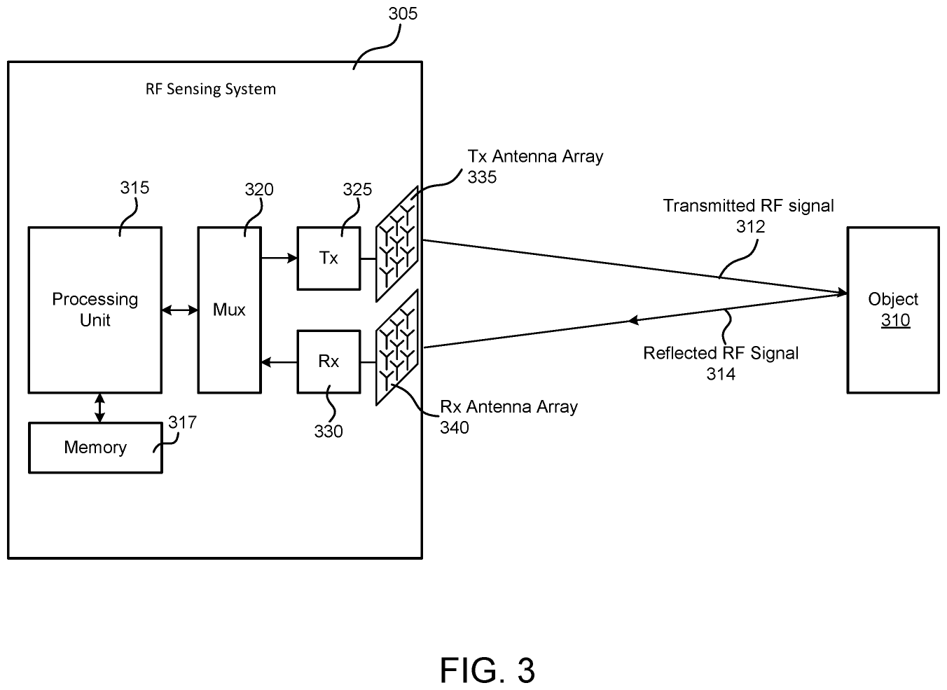

The principles described above with respect to UE-assisted positioning, UE-based positioning, UL-based positioning, DL-based positioning, and DL-UL based positioning may be generally extended to RF sensing. That is, RF sensing may be UE-based (e.g., originated from the UE) and/or UE assisted (e.g., originated from a non-UE entity), and may involve UL signals, DL signals, or both. However, RF sensing may differ from positioning in various ways. For example, as previously noted, RF sensing may involve the use of positioning reference signal (PRS), sounding reference signal (SRS), synchronization signal block (SSB), channel start information reference signal (CSI-RS), or any combination thereof. Further, RF sensing may be performed in a monostatic, bistatic, or multi-static manner, as described above, where RF sensing nodes comprise a UE (e.g., UE 205) and/or one or more access nodes (e.g., gNBs 210, ng-eNB 214, WLAN 216, NTN satellites 110, or any combination thereof). Various aspects of RF sensing are described below FIG in more detail with respect to FIG. 3.

FIG. 3 is a diagram showing an example of an RF sensing system 305 and associated terminology. As used herein, the terms “waveform” and “sequence” and derivatives thereof are used interchangeably to refer to RF signals generated by a transmitter of the RF sensing system and received by a receiver of the RF sensing system for object detection. A “pulse” and derivatives thereof are generally referred to herein as waveforms comprising a sequence or complementary pair of sequences transmitted and received to generate a channel impulse response (CIR). The RF sensing system 305 may comprise a standalone device or may be integrated into a larger electronic device such as, for example, the UE 205 described above. It can be noted that although the example RF sensing system 305 of FIG. 3 is illustrated in a monostatic configuration, embodiments are not so limited. As noted elsewhere herein, RF sensing nodes may be configured to perform RF sensing in a monostatic, bistatic, or multi-static configuration, or any combination thereof (e.g., depending on the circumstances of a particular instance). As such, components of an RF sensing system 305 within an RF sensing node may vary. For example, RF sensing nodes performing only transmitting or only receiving during RF sensing may include only respective components related to the transmitting or receiving. Again, embodiments may vary, depending on desired functionality.

With regard to the functionality of the RF sensing system 305 in FIG. 3, the RF sensing system 305 can detect the distance, direction, and/or speed of objects of an object 310 by generating a series of transmitted RF signals 312 (comprising one or more pulses). Some of these transmitted RF signals 312 reflect off of the object 310, and these reflected RF signals 314 (or “echoes”) are then processed by the RF sensing system 305 using beamforming (BF) and digital signal processing (DSP) techniques to determine the object's location (azimuth, elevation, velocity (e.g., from Doppler measurements), and range) relative to the RF sensing system 305.

To enable RF sensing, RF sensing system 305 may include a processing unit 315, memory 317, multiplexer (mux) 320, Tx processing circuitry 325, and Rx processing circuitry 330. (The RF sensing system 305 may include additional components not illustrated, such as a power source, user interface, or electronic interface). It can be noted, however, that these components of the RF sensing system 305 may be rearranged or otherwise altered in alternative embodiments, depending on desired functionality. Moreover, as used herein, the terms “transmit circuitry” or “Tx circuitry” refer to any circuitry utilized to create and/or transmit the transmitted RF signal 312. Likewise, the terms “receive circuitry” or “Rx circuitry” refer to any circuitry utilized to detect and/or process the reflected RF signal 314. As such, “transmit circuitry” and “receive circuitry” may not only comprise the Tx processing circuitry 325 and Rx processing circuitry 330 respectively but may also comprise the mux 320 and processing unit 315. In some embodiments, the processing unit may compose at least part of a modem and/or wireless communications interface. In some embodiments, more than one processing unit may be used to perform the functions of the processing unit 315 described herein.

The Tx processing circuitry 325 and Rx circuitry 330 may comprise subcomponents for respectively generating and detecting RF signals. As a person of ordinary skill in the art will appreciate, the Tx processing circuitry 325 may therefore include a pulse generator, digital-to-analog converter (DAC), a mixer (for up-mixing the signal to the transmit frequency), one or more amplifiers (for powering the transmission via Tx antenna array 335), etc. The Rx processing circuitry 330 may have similar hardware for processing a detected RF signal. In particular, the Rx processing circuitry 330 may comprise an amplifier (for amplifying a signal received via Rx antenna array 340), a mixer configured to perform FMCW demodulation, a filter to block undesired signals in the mixer output, an analog-to-digital converter (ADC) for digitizing the demodulated signal, and a pulse correlator providing a matched filter for the pulse generated by the Tx processing circuitry 325. The Rx processing circuitry 330 may therefore use the correlator output as the CIR, which can be processed by the processing unit 315 (or other circuitries). Processing of the CIR may include object detecting, range, speed, or direction of arrival (DoA) estimation.

Beamforming is further enabled by a Tx antenna array 335 and an Rx antenna array 340. Each antenna array 335, 340 comprises a plurality of antenna elements. It can be noted that, although the antenna arrays 335, 340 of FIG. 3 include two-dimensional arrays, embodiments are not so limited. Arrays may simply include a plurality of antenna elements along a single dimension that provides for spatial cancellation between the Tx and Rx sides of the RF sensing system 305. As a person of ordinary skill in the art will appreciate, the relative location of the Tx and Rx sides, in addition to various environmental factors can impact how spatial cancellation may be performed.

It can be noted that the properties of the transmitted RF signal 312 may vary, depending on the technologies utilized. Techniques provided herein can apply generally to “mm Wave” technologies, which typically operate at 57-71 GHz, but may include frequencies ranging from 30-300 GHz. This includes, for example, frequencies utilized by the 802.11ad Wi-Fi standard (operating at 60 GHZ). That said, some embodiments may utilize RF signals with frequencies outside this range. For example, in some embodiments, 5G frequency bands (e.g., 28 GHZ) may be used.

Because RF sensing may be performed in the same frequency bands as communication (e.g., cellular and/or WLAN communication), hardware may be utilized for both communication and RF sensing, as previously noted. For example, one or more of the components of the RF sensing system 305 shown in FIG. 3 may be included in a wireless modem (e.g., Wi-Fi, 5G, or other modems). Additionally, techniques may apply to RF signals comprising any of a variety of pulse types, including compressed pulses (e.g., comprising Chirp, Golay, Barker, or Ipatov sequences) may be utilized. That said, embodiments are not limited to such frequencies and/or pulse types. Additionally, because the RF sensing system may be capable of sending RF signals for communication (e.g., using 802.11 communication technology), embodiments may leverage channel estimation used in communication for performing the RF sensing as provided herein. Accordingly, the pulses may be the same as those used for channel estimation in communication.

As noted, the RF sensing system 305 may be integrated into an electronic device in which RF sensing is desired. For example, the RF sensing system 305, which can perform RF sensing, may be part of communication hardware found in modern mobile phones. Other devices, too, may utilize the techniques provided herein. These can include, for example, other mobile devices (e.g., tablets, portable media players, laptops, wearable devices, other electronic devices (e.g., security devices, on-vehicle systems, specialized or dedicated RF sensing devices), wireless nodes of the communication network (e.g., access nodes, such as base stations and/or satellites), or the like. That said, electronic devices (e.g., RF sensing nodes) into which an RF sensing system 305 may be integrated are not limited to such devices.

In RF sensing, a wireless signal can be transmitted from one or multiple transmit points and received at one or multiple receive points after being reflected off a target. RF sensing can enable many candidate applications, including intruder detection, animal/pedestrian/unmanned aerial vehicle (UAV) intrusion detection in highways and railways, rainfall monitoring, flooding awareness, autonomous driving, automated guided vehicle (AGV) detection/tracking/collision avoidance, smart parking and assistance, UAV trajectory and tracking, crowd management, sleep/health monitoring, gesture recognition, XR streaming, public safety, search and rescue, and more. Further, RF sensing is expected to be incorporated into wireless standards (e.g., 6G), and therefore may be performed in the future in a cellular network.

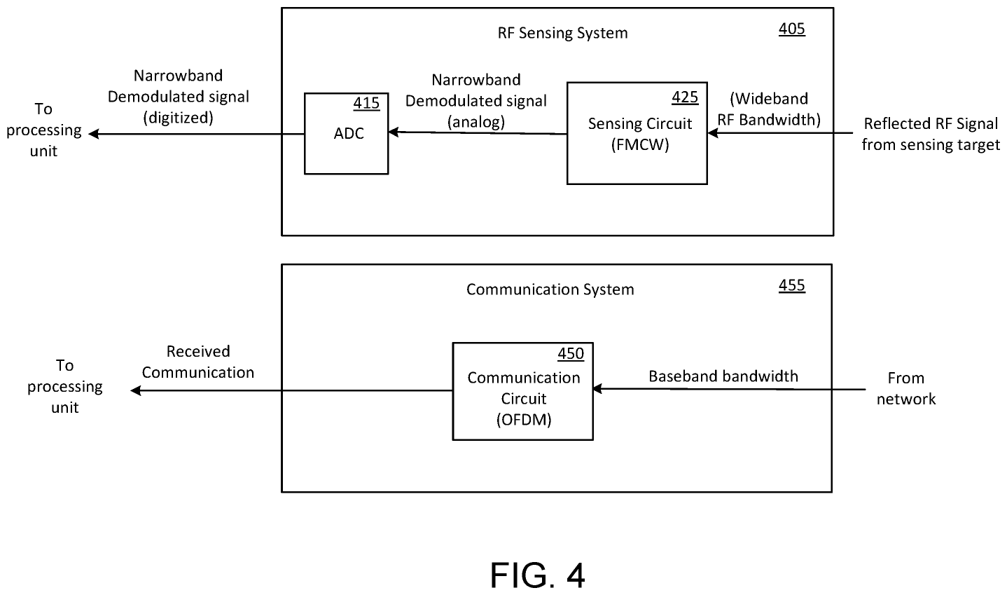

FIG. 4 is a diagram showing some example functional elements of the UE 205 described above. The example elements include an RF sensing system 405 and a communication system 455. The RF sensing system 405 can include some or all of the components described above with reference to the RF sensing system 305 and can be used to perform various functions such as those described with reference to the RF sensing system 305, particularly, the Rx processing circuitry 330.

In the illustrated example, the RF sensing system 405, which is shown configured to perform a sensing operation, includes a sensing circuit 425 and an analog-to-digital converter (ADC) 415. The sensing circuit 425 can include, for example, an amplifier (for amplifying the reflected RF signal received from a sensing target via Rx antenna array 340), a mixer configured to perform FMCW demodulation, a filter to block undesired signals in the mixer output, and other components for conditioning and processing the signal. In an example embodiment, the sensing circuit 425 is configured to operate in an FMCW mode of operation wherein a wideband RF signal is converted into an analog demodulated signal occupying a bandwidth that is narrower than the RF bandwidth. The demodulation may be performed, for example, by use of a mixer and a FMCW local oscillator (LO). The narrowband demodulated signal (analog) can be coupled into the ADC 415 for digitizing. The output of the ADC 415 is in a digital format and can contain information related to, for example, detection of an object, a distance/range/angle at which the object is detected, a speed of movement of the object (if moving), and/or a direction of arrival (DoA) estimation. The information may be operated upon by other components that can include, for example, the processing unit 315 described above.

The ADC 415 in this arrangement can be a low-speed ADC that receives the demodulated signal occupying a narrow bandwidth in lieu of a high-speed ADC that may be used in a conventional arrangement in which the high-speed ADC is configured to operate directly upon a wideband reflected RF signal received from a sensing target. The use of a low-speed ADC having a low sampling rate provides various advantages in accordance with the disclosure, such as, for example, advantages associated with costs, complexity, and power consumption. The processing performed upon the output of the ADC 415 can include Fast Fourier Transform operations. Timing factors associated with the analog-to-digital conversion by the ADC 415 and the Fast Fourier Transform operations performed upon the digitized output of the ADC 415 generally characterize operations of the RF sensing system 405 in the FMCW domain. These timing factors may be used for various purposes such as, for example, to optimize power consumption, to define switching requirements between FMCW domain operations associated with sensing procedures and OFDM operations associated with communication procedures, and to ensure interoperability between the UE 205 and other equipment.

The communication system 455 can be used for communications purposes such as, for example, communications between the UE 205 and one or more components of the NG-RAN 235 and/or between the UE 205 and the WLAN 216 (shown in FIG. 2). In various embodiments, the communication system 455 can be operated concurrently with the RF sensing system 405 for performing communications and RF sensing operations concurrently. Such concurrent operations, which can also be referred to as joint operations, may be particularly applicable to joint communication and sensing (JCS) operations performed by sixth-generation (6G) systems. In the illustrated example, the communication system 455 includes a communication circuit 450 configured to operate in an orthogonal frequency division multiplexing (OFDM) mode of operation. An input to the communication circuit 450 is a downstream RF signal occupying a baseband bandwidth. The baseband bandwidth has already been predefined in current practice and can be referred to alternatively as a legacy bandwidth.

In an example use case, the baseband bandwidth can be, for example, 400 MHz. In an example usage scenario, such as, for example, in a 6G system, the RF bandwidth associated with the RF signal used by the RF sensing system 405 for sensing purposes can be larger than the baseband bandwidth. In an example use case, the RF BWP can be much larger than the baseband bandwidth such as, for example, 1 GHZ.

The communication output of the communication circuit 450 can be provided to components such as, for example, the processing unit 315 described above. In an example implementation, the communication system 455 can also be used to communicate with a configuration node such as, for example, a component of the NG-RAN 235 an/or a component of the 5G core network 240 shown in FIG. 2. The communications can be directed, for example, at requesting and obtaining support for the RF bandwidth used by the RF sensing system 405. In an example implementation, the support may be provided to UE 205 by a configuring node in the form of configuration information such as, for example, a message indicating allocation of a first RF bandwidth part (BWP) to the UE 205.

As described above, a wideband RF signal can be used for performing a sensing operation by the UE 205. The use of a wideband RF signal for sensing purposes provides various advantages over an RF signal occupying a smaller bandwidth such as, for example, by providing higher precision information associated with a sensing target (location, range, angle, direction, orientation, Doppler, velocity, etc.).

According to embodiments described herein, the RF BWP of the wideband RF signal can be flexibly defined and can vary from UE to UE in terms of use and/or in terms of capabilities of a UE. Thus, for example, a first UE may be configured to operate with a first RF BWP for performing a first type of sensing operation and reconfigured to operate with a second RF BWP for performing a second type of sensing operation at a different time. The second RF BWP may be smaller than the first RF BWP when the second type of sensing operation does not require the same level of performance as the first type of sensing operation, and vice-versa.

A second UE may be configured to operate with a third RF BWP that is, for example, smaller than the first BWP and/or the second RF BWP used by the first UE because the second UE is configured to perform, or is capable of performing, a third type of sensing operation that does not require the same level of performance as the first and/or second type of sensing operations performed by the first UE.

Interoperability between a UE and a network device such as, for example, an access device, can be dependent upon configuring the UE and the network device to be compatible with each other for supporting operations based on a specified RF BWP for sensing operations performed by the UE. For example, interoperability of the UE 205 and gNB 210 (as illustrated in FIG. 2) can be dependent upon the UE 205 informing the gNB 210 of a capability and/or desirability of the UE 205 to utilize a specified RF bandwidth for sensing operations performed by the UE 205 and the gNB 210 acknowledging the information, allocating an RF BWP, and configuring the gNB 210 to interact with the UE 205 on the basis of the RF BWP. Further details pertaining to this aspect are described below.

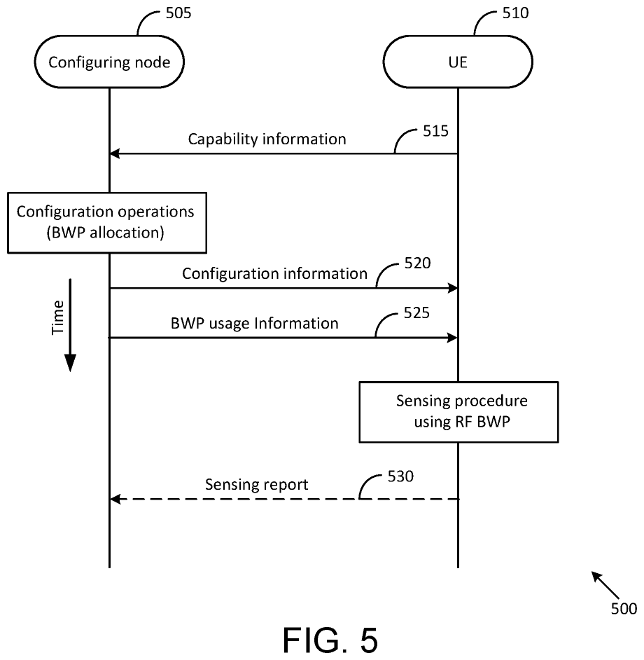

FIG. 5 is a flow diagram 500 showing information exchange between a UE and a configuring node to enable the UE to utilize an RF BWP in accordance with an embodiment of the disclosure. The information exchange can be performed in various ways and by use of various formats. In an example embodiment, at least a portion of the information exchange can be conducted by use of a radio resource control (RRC) protocol.

The UE 510 and the configuring node 505 can be the UE 205 and the gNB 210 respectively, as shown in FIG. 2 and the communications between the UE 510 and the configuring node 505 may be carried out, for example, by means of the Uu interface 239 shown in FIG. 2. The information exchange between the UE 510 and the configuring node 505 may begin with the functionality indicated by arrow 515, in which the UE 510 transmits to the configuring node 505, capability information of the UE 510.

In an example embodiment, the capability information can include an indication of a radio frequency (RF) bandwidth supported by the UE 510 for performing sensing functions. For example, a first type of UE 510 may have a capability to perform high resolution sensing operations using wideband RF signals and may inform the configuring node 505 of the capability of the first user device to use a wideband RF bandwidth that is suitable for performing the high resolution sensing operations. A second type of UE 510 may have a limited capability to perform sensing operations and may inform the configuring node 505 of the capability of the second type of UE 510 to use a limited RF bandwidth that is adequate for performing these sensing operations.

In an example implementation, the radio frequency (RF) bandwidth indicated in the capability information transmitted by the UE 510 to the configuring node 505 can be determined based on the capabilities of RF sensing system 405 shown in FIG. 4 (FMCW capability of the sensing circuit 425, sampling rate of ADC 415, and FFT operations).

In another example embodiment, the functionality indicated by arrow 515 can involve the UE 510 transmitting to the configuring node 505, a request for allocation of an RF BWP specified by the UE 510, in lieu of, or in addition to, the RF bandwidth indicated in the capability information described above. In this scenario, the configuring node 505 may consider the request based on one or more factors such as, for example, a channel bandwidth made available to the base station for BWP assignments and a number of user devices supported by the base station. The requested RF BWP may be specified, for example, by a user of the UE 510 based on a first sensing operation that is expected to be performed by the UE 510 and may be subsequently modified for a different sensing operation.

In another example embodiment, the functionality indicated by arrow 515 can involve the UE 510 transmitting to the configuring node 505, information pertaining to one or more switch times associated with the UE 510. A “switch time” may also be referred to herein as a “switching delay.” In one case, the switch time(s) information may be transmitted to the configuring node 505 as a part of the capability information described above. A first example of a switch time pertains to an amount of time that the UE 510 takes (switching delay) to switch from using an RF BWP (for sensing operations) to using a baseband BWP (for communication purposes).

The switch time may be determined based on transitioning from an FMCW mode of operation (using the RF BWP and FMCW numerologies) to an OFDM mode of operation (using the baseband BWP and OFDM numerologies). The FMCW mode of operation may use one or more symbol durations that are different than those used in OFDM operations (legacy operations).

A second example of a switch time pertains to an amount of time that the UE 510 takes to switch from using the baseband BWP to an RF BWP. The switch time, which may be determined based on transitioning from an OFDM mode of operation to an FMCW mode of operation can be different than the switch time described above (switching from FMCW to OFDM).

A third example of a switch time pertains to an amount of time that the UE 510 takes for switching from using a first RF BWP to a second RF BWP. In this case, the switch time may be based on FMCW numerologies associated with the first RF BWP and the second RF BWP.

The configuring node 505 evaluates the capability information and/or the requested BWP received from the UE 510 and allocates one or more BWPs to the UE 510. In an example implementation, the configuring node 505 may be configured to support the UE 510 to perform concurrent processing of FMCW waveforms and OFDM waveforms based on a RF BWP and a baseband BWP respectively. In another example implementation, the configuring node 505 may be unable to support concurrent processing of FMCW waveforms and OFDM waveforms by the UE 510, and may consequently, support the UE 510 perform operations upon only one of the FMCW waveforms or the OFDM waveforms over any selected periods of time.

Arrow 520 indicates a functionality wherein the configuring node 505 conveys to the UE 510, information about support for one or more BWPs allocated to the UE 510. In an example implementation, arrow 520 indicates a functionality wherein the configuring node 505 conveys to the UE 510, information about an RF BWP allocated to the UE 510. The baseband BWP may be already allocated to the UE 510 at this time. In one embodiment, the information provided by the configuring node 505 to the UE 510 can be one or more configuration messages formatted in a radio resource control (RRC) protocol.

Arrow 525 indicates a functionality wherein the configuring node 505 conveys to the UE 510, information pertaining to usage of the one or more BWPs allocated to the UE 510 by the configuring node 505. The usage information can include, for example, details about times when the one or more BWPs, particularly the RF BWP, can be used by the UE 510. In an example implementation, the information can be activation information conveyed to the UE 510 in a downlink control information (DCI) format or in a MAC control element (MAC CE) format.

In at least some embodiments, the functions described above with reference to arrow 515, arrow 520, and arrow 525 can be interpreted as a provisioning handshake procedure. The provisioning handshake procedure can be performed in various alternative ways. For example, the functionality indicated by arrow 515 may be carried out in the form of the UE 510 transmitting a configuration request (in addition to, or in lieu of, the capability report) to the configuring node 505. The configuration request may be based, for example, on a desired RF BWP for a sensing operation performed over a first period of time and another configuration request may be submitted at a different time for a different sensing operation (different RF BWP) over a second period of time.

After receiving the acknowledgement of support from the configuring node 505 (indicated by arrow 520), the UE 510 may perform a sensing operation such as, for example, by using the RF sensing system 405 described above.

Arrow 530 indicates an optional functionality wherein the UE 510 can transmit a sensing report to the configuring node 505, such as, for example, a sensing report containing information associated with the sensing procedure performed by the UE 510. In some cases, information associated with the sensing procedure may be made available to a user of the UE 510 and may not be transmitted to the configuring node 505.

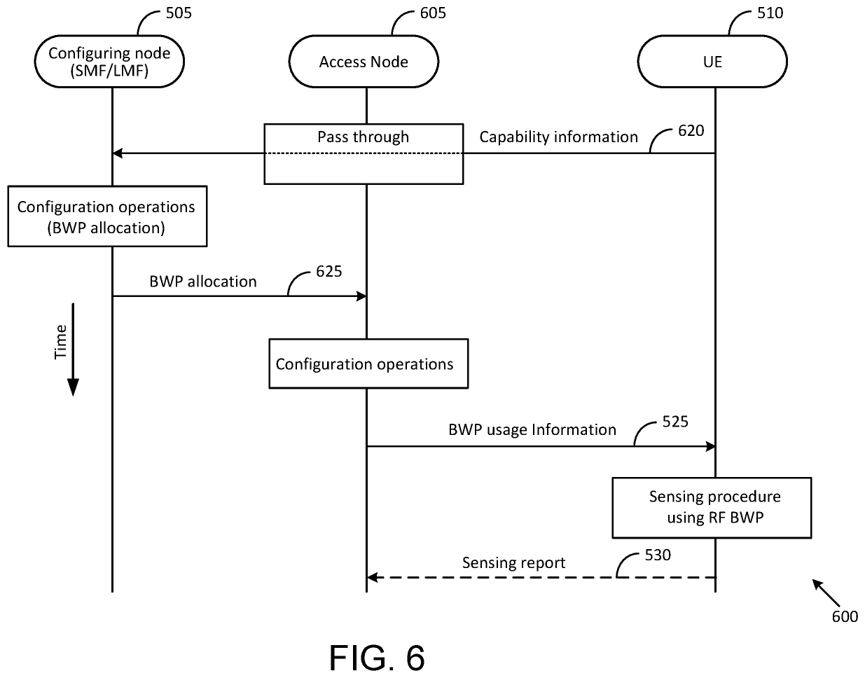

FIG. 6 is a flow diagram 600 showing information exchange between a UE and a configuring node to enable the UE to utilize an RF BWP in accordance with another embodiment of the disclosure. In this example embodiment, the configuring node 505 is a device that is communicatively coupled to the UE 510 via an access node 605. The configuring node 505 in this embodiment can be, for example, the ANF 215 and/or a server (such as, for example, the SMF 221 shown in FIG. 2). The access node 605 can be, for example, gNB 210 or ng-eNB 214. The access node 605 operates in a flow-through mode to convey to the configuring node 505, the capability information transmitted by the UE 510 (as indicated by arrow 620). The configuring node 505 performs configuration operations in the manner described above with respect to the configuring node 505 shown in FIG. 6.

Arrow 625 indicates a functionality wherein the configuring node 505 provides an indication of support for one or more BWPs allocated to the UE 510 by the configuring node 505. In an example implementation, arrow 625 indicates a functionality wherein the configuring node 505 conveys to the access node 605, information about an RF BWP allocated to the UE 510. The baseband BWP may be already allocated to the UE 510 at this time.

The access node 605 receives the information about the allocated BWP(s) and performs the functionality described above with reference to arrow 525. Subsequent operations can be similar to the operations described above with reference to FIG. 5.

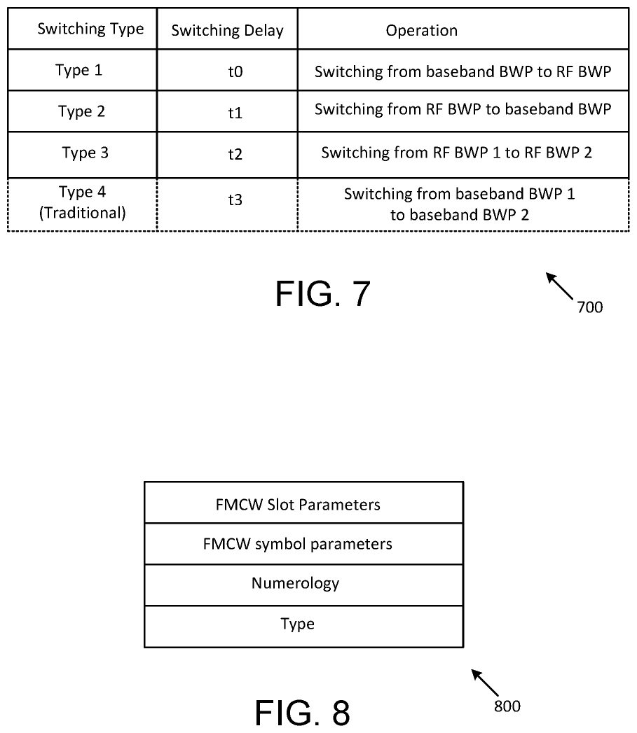

FIG. 7 shows a table 700 that includes some types of switching delays associated with some example operations performed in accordance with the disclosure. The table 700 includes a first example entry that is defined as Switching Type 1 that is associated with a switching delay “t0” when switching from a baseband BWP operation to an RF BWP operation. The table 700 further includes a second example entry that is defined as Switching Type 2 that is associated with a switching delay “t1” when switching from a RF BWP operation to a baseband BWP operation. Switching delay “t1” can be different than switching delay “t0.” The table 700 further includes a third example entry that is defined as Switching Type 3 that is associated with a switching delay “t2” when switching from one RF BWP operation to another RF BWP operation. Switching delay “t2” can be different than switching delay “t0” and switching delay “t1.” Each of the switching types may be defined and used in accordance with individual capabilities of various types of UEs.

In an example implementation, the table 700 can be an adaptation of a table that is used in existing practice (in OFDM based communication practice). In this case, the table 700 can include a Switching Type 4 that may be associated with a switching delay “t3” when switching from using a first baseband BWP to using a second baseband BWP.

FIG. 8 shows a table 800 that includes some example parameters that can be associated with FMCW operations in accordance with the disclosure. In an example embodiment, the table 700, or a modified version of the table 700, can be defined in a format based on modifying a format used in current practice for FMCW applications. Modifying the format can include, for example, modifying numerologies, modifying symbol durations, modifying integer numbers that define sensing slots, and/or modifying slot durations. A sensing slot can be configured to include multiple FMCW signals, and each integer number may be defined as a function of a FMCW slot duration. Furthermore, an FMCW slot duration may be set to be different than an OFDM slot duration.

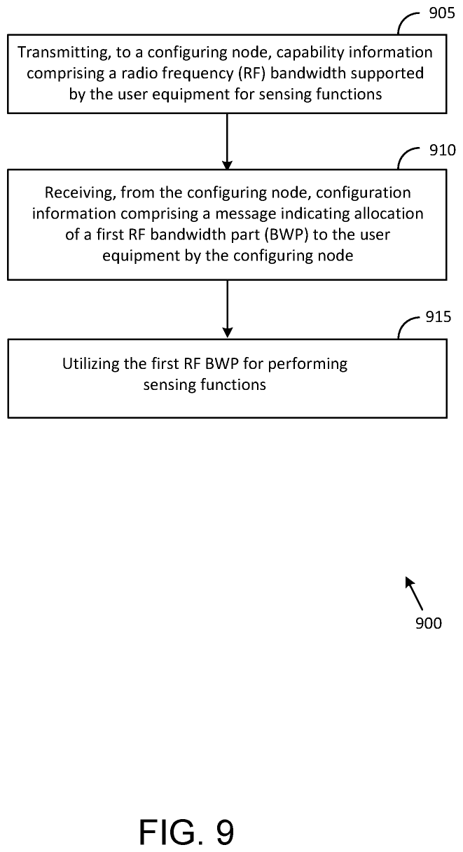

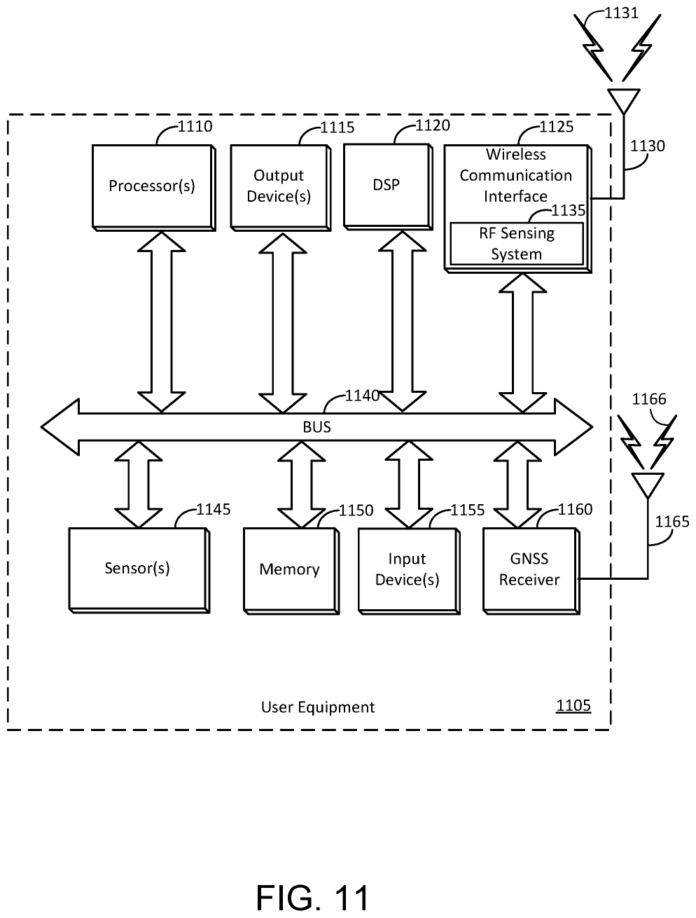

FIG. 9 shows a flowchart 900 of a method performed by a user equipment (such as, for example, UE 205) for executing sensing functions. Means for performing the functionality illustrated in one or more of the blocks shown in FIG. 9 may be performed by hardware and/or software components of the various components such as the components illustrated in FIG. 11. The description below refers to various example components described herein but it must be understood that the functions can be performed by various other components that may be functionally identical or functionally similar.

At block 905, the functionality can include transmitting, to a configuring node, capability information comprising a radio frequency (RF) bandwidth supported by the user equipment for sensing functions. The configuring node can be, for example, a base station of a cellular network or a server of the cellular network. The capability information can vary from one UE to another. For example, a first type of UE may have a capability to perform high resolution sensing operations using wideband RF signals and may inform the configuring node of the capability of the first user device to use a wideband RF bandwidth that is suitable for performing the high resolution sensing operations. A second type of UE may have a limited capability to perform sensing operations and may inform the configuring node of the capability of the second type of UE to use a limited RF bandwidth that is adequate for performing these sensing operations. In an example implementation, the RF bandwidth indicated in the capability information transmitted by the UE to the configuring node can be determined based on the capabilities of a RF sensing system that can be a part of the UE. In an embodiment, the capability information may be transmitted to the configuring node based on an RRC protocol.

At block 910, the functionality can include receiving, from the configuring node, configuration information comprising a message indicating allocation of a first RF bandwidth part (BWP) to the user equipment by the configuring node. Some additional aspects pertaining to such allocation are described above with reference to FIG. 5.

At block 915, the functionality can include the UE utilizing the first RF BWP for performing sensing functions. In an example implementation, the user device may utilize the RF BWP for performing sensing operations at some times and may utilize what is referred to herein as a “baseband BWP” for communication purposes at some other times. The RF BWP is typically larger than the baseband BWP. Communication operations can be based, at least in part, on orthogonal frequency division multiplexing (OFDM) and sensing functions can be based, at least in part, on using frequency modulated continuous wave (FMCW) operations.

The capability information transmitted by the UE to the configuring node may also include a first switching time supported by the UE for switching between the baseband BWP and the first RF BWP and may further include a second switching time supported by the UE for switching between the first RF BWP and a second RF BWP. The second switching time may be defined, at least in part, on a first symbol duration in an FMCW format and/or a first sensing slot in the FMCW format

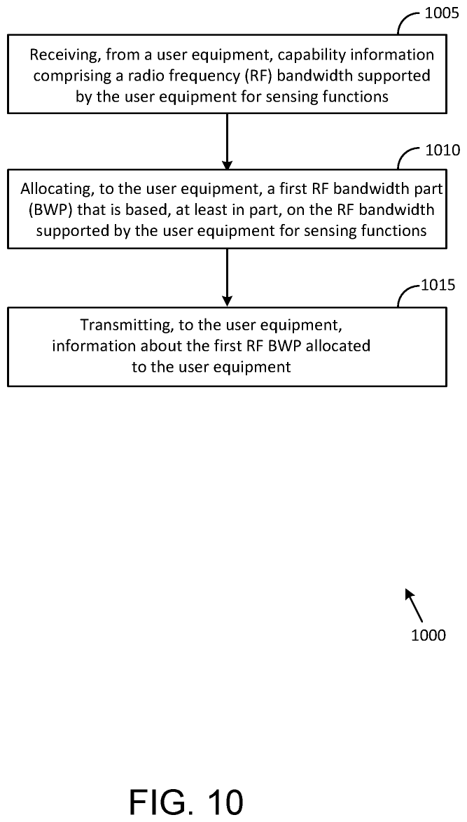

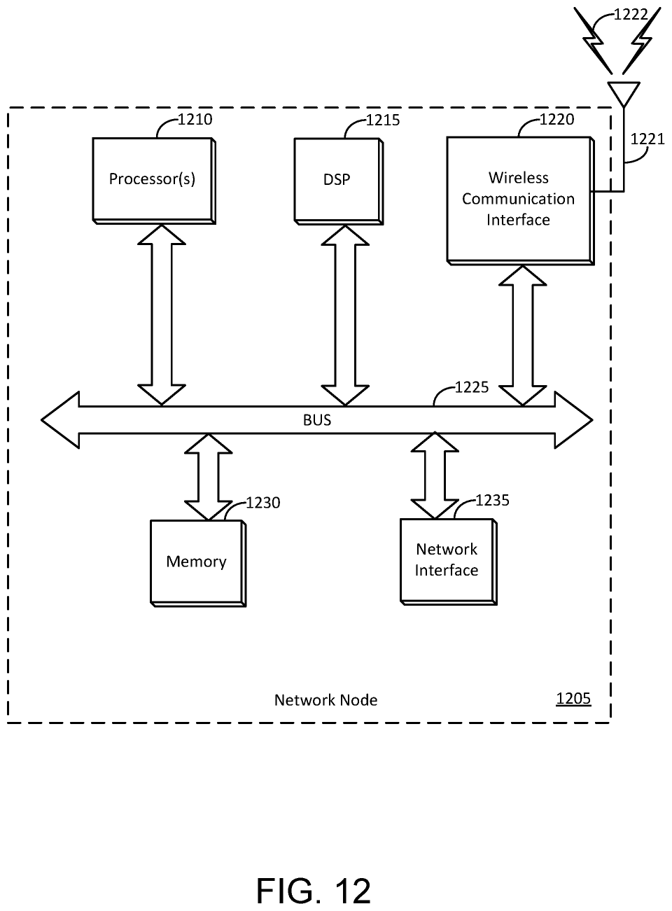

FIG. 10 shows a flowchart 1000 of a method performed by a configuring node to support a user equipment for performing sensing functions. Means for performing the functionality illustrated in one or more of the blocks shown in FIG. 10 may be performed by hardware and/or software components of the various components such as the components illustrated in FIG. 12. Several portions of the description provided above with reference to the flowchart 900 are equally pertinent to the flowchart 1000 and must be understood as such.

At block 1005, the functionality can include receiving, from the user equipment, capability information that includes a RF bandwidth supported by the user equipment for sensing functions. The configuring node can be, for example, a base station of a cellular network or a server of the cellular network. Some aspects pertaining to the capability information are described above.

At block 1010, the functionality can include allocating, to the UE, a first RF BWP that is based, at least in part, on the RF bandwidth supported by the UE for sensing functions. Some aspects pertaining to RF BWP are described above.

At block 1015, the functionality can include transmitting, to the UE, information about the first RF BWP allocated to the UE.

FIG. 11 shows a block diagram of a user equipment 1105 in accordance an embodiment of the disclosure. For example, user equipment 1105 may correspond the mobile device 105 shown in FIG. 1 or the UE 205 shown in FIG. 2. Further, as described below, the user equipment 1105 may implement an RF sensing system 1135, which can correspond to the RF sensing system 305 described above with respect to FIG. 3 or the RF sensing system 405 described above with respect to FIG. 4. It should be noted that FIG. 11 is meant only to provide a generalized illustration of various components, any or all of which may be utilized as appropriate. Furthermore, as previously noted, the functionality of the UE discussed in the previously described embodiments may be executed by one or more of the hardware and/or software components illustrated in FIG. 11.

The user equipment 1105 is shown comprising hardware elements that can be electrically coupled via a bus 1140 (or may otherwise be in communication, as appropriate). The hardware elements may include a processor(s) 1110 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1110 may comprise one or more processing units, which may be housed in a single integrated circuit (IC) or multiple ICs. As shown in FIG. 11, some embodiments may have a separate DSP 1120, depending on desired functionality. Sensing operations based on wireless communication may be provided in the processor(s) 1110 and/or wireless communication interface 1125 (discussed below). The user equipment 1105 also can include one or more input devices 1155, which can include without limitation one or more keyboards, touch screens, touch pads, microphones, buttons, dials, switches, and/or the like; and one or more output devices 1115, which can include without limitation one or more displays (e.g., touch screens), light emitting diodes (LEDs), speakers, and/or the like.

The user equipment 1105 may also include a wireless communication interface 1125, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the user equipment 1105 to communicate and/or perform various operations as described in the embodiments above, with respect to WLAN and/or cellular technologies. The wireless communication interface 1125 may permit data and signaling to be communicated (e.g., transmitted and received) with NG-RAN nodes of a network, for example, via eNBs, gNBs, ng-eNBs, access points, NTN satellites, various base stations, TRPs, and/or other access node types, and/or other network components, computer systems, and/or any other electronic devices communicatively coupled with TRPs, as described herein. The communication can be carried out via one or more wireless communication antenna(s) 1130 that send and/or receive wireless signals 1131. According to some embodiments, the wireless communication antenna(s) 1130 may comprise a plurality of discrete antennas, antenna arrays, or any combination thereof. The antenna(s) 1130 may be capable of transmitting and receiving wireless signals using beams (e.g., Tx beams and Rx beams). Beam formation may be performed using digital and/or analog beam formation techniques, with respective digital and/or analog circuitry. The wireless communication interface 1125 may include such circuitry.

As noted above, the mobile device 105 and/or the UE 205 may implement an RF sensing system 1135. The RF sensing system 1135 may comprise the hardware and/or software elements described above with respect to FIG. 3 and FIG. 4. As illustrated in FIG. 11 and noted above, some or all of the RF sensing system 1135 may be implemented within a wireless communication interface 1125, which may utilize certain components for both communication and RF sensing. That said, embodiments are not so limited. Alternative embodiments may implement some or all of the RF sensing system 1135 separate from the wireless communication interface 1125 (e.g., in cases where RF sensing may utilize different frequencies and/or different hardware/software components then the wireless communication interface 1125).

Depending on desired functionality, the wireless communication interface 1125 may comprise a separate receiver and transmitter, or any combination of transceivers, transmitters, and/or receivers to communicate with base stations (e.g., ng-eNBs and gNBs) and other terrestrial transceivers, such as wireless devices and access points, as well as NTN satellites. The user equipment 1105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The user equipment 1105 can further include sensor(s) 1145. Sensor(s) 1145 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain sensing-related measurements and/or other information. Sensors 1145 may be used, for example, to detect an object and various characteristics associated with the object.

Embodiments of the user equipment 1105 may also include a Global Navigation Satellite System (GNSS) receiver 1160 capable of receiving signals 1166 from one or more GNSS satellites using an antenna 1165 (which could be the same as antenna 1130). Positioning based on GNSS signal measurement can be utilized to complement and/or incorporate the techniques described herein. The GNSS receiver 1160 can extract a position of the user equipment 1105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1160 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1160 is illustrated in FIG. 11 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1110, DSP 1120, and/or a processor within the wireless communication interface 1125 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1110 or DSP 1120.

The user equipment 1105 may further include and/or be in communication with a memory 1150. The memory 1150 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1150 of the user equipment 1105 also can comprise software elements (not shown in FIG. 11), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1150 that are executable by the user equipment 1105 (and/or processor(s) 1110 or DSP 1120 within user equipment 1105). In some embodiments, then, such code and/or instructions can be used to configure and/or adapt a general-purpose computer (or other device) to perform one or more operations in accordance with the described methods.

FIG. 12 is a block diagram of a network node 1205 in accordance an embodiment of the disclosure. According to some embodiments, the network node 1205 may function as a configuring node as described herein. As such, the network node 1205 may be capable of performing some or all of the functionality described in the method shown in FIG. 10. It should be noted that FIG. 12 is meant only to provide a generalized illustration of various components, any or all of which may be utilized as appropriate. In some embodiments, the network node 1205 may correspond to the gNB 210, the ng-eNB 214, ANF 215, or the SMF 221 shown in FIG. 2 and/or (more generally) a TRP. In some cases, the network node 1205 may comprise multiple TRPs—e.g. with each TRP associated with a different antenna or a different antenna array of the network node 1205. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP.

The functionality performed by the network node 1205 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. The functionality of these functional components may be performed by one or more of the hardware and/or software components illustrated in FIG. 12.

The network node 1205 is shown comprising hardware elements that can be electrically coupled via a bus 1225 (or may otherwise be in communication, as appropriate). The hardware elements may include a processor(s) 1210 which can include without limitation one or more general-purpose processors, one or more special-purpose processors (such as digital signal processor (DSP) chips, graphics acceleration processors, application-specific integrated circuits (ASICs), and/or the like), and/or other processing structure or means. As shown in FIG. 12, some embodiments may have a separate DSP 1215, depending on desired functionality. The network node 1205 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The network node 1205 might also include a wireless communication interface 1220, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the network node 1205 to communicate as described herein. The wireless communication interface 1220 may permit data and signaling to be communicated (e.g., transmitted and received) to UEs, other base stations/TRPs (e.g., eNBs, gNBs, and ng-eNBs), and/or other network components, computer systems, and/or other electronic devices described herein. The communication can be carried out via one or more wireless communication antenna(s) 1221 that send and/or receive wireless signals 1222. According to some embodiments, one or more wireless communication antenna(s) 1221 may comprise one or more antenna arrays, which may be capable of beamforming.

The network node 1205 may also include a network interface 1235, which can include support of wireline communication technologies. The network interface 1235 may include a modem, network card, chipset, and/or the like. The network interface 1235 may include one or more input and/or output communication interfaces to permit data to be exchanged with a network, communication network servers, computer systems, and/or any other electronic devices described herein.

In many embodiments, the network node 1205 may further comprise a memory 1230. The memory 1230 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1230 of the network node 1205 also may comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1230 that are executable by the network node 1205 (and/or processor(s) 1210 or DSP 1215 within network node 1205). In some embodiments, then, such code and/or instructions can be used to configure and/or adapt a general-purpose computer (or other device) to perform one or more operations in accordance with the described methods.

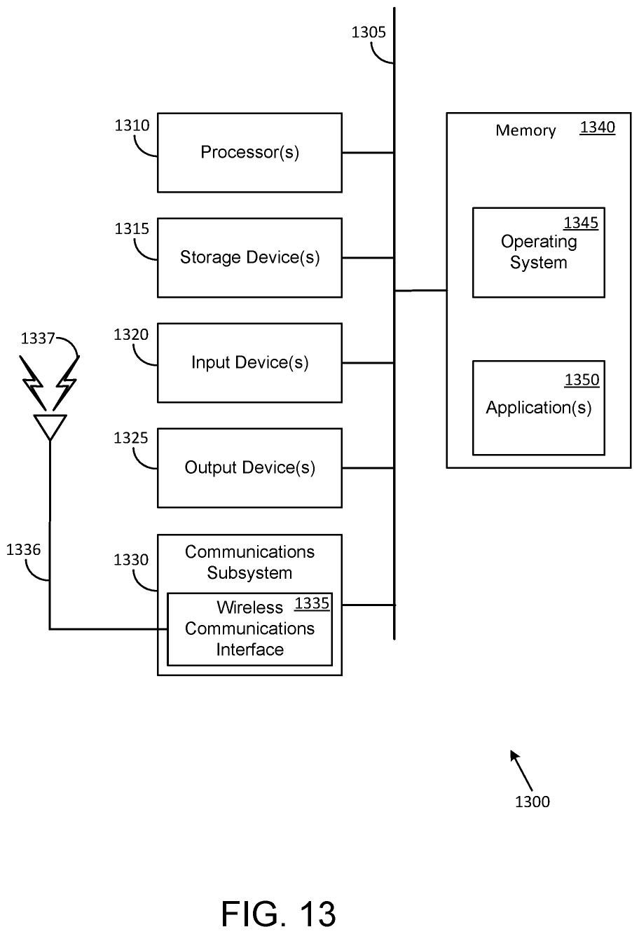

FIG. 13 is a block diagram of an embodiment of a computer system 1300, which may be used, in whole or in part, to provide the functions of one or more components and/or devices as described in the embodiments herein. The computer system 1300, for example, may be utilized within and/or executed by a server (e.g., SMF 221), which may perform the functions of a configuring node (e.g., configuring node 505 of FIG. 6 and FIG. 7) as described herein. It should be noted that FIG. 13 is meant only to provide a generalized illustration of various components, any or all of which may be utilized as appropriate. FIG. 13, therefore, broadly illustrates how individual system elements may be implemented in a relatively separated or relatively more integrated manner. In addition, it can be noted that components illustrated by FIG. 13 can be localized to a single device and/or distributed among various networked devices, which may be disposed at different geographical locations.

The computer system 1300 is shown comprising hardware elements that can be electrically coupled via a bus 1305 (or may otherwise be in communication, as appropriate). The hardware elements may include processor(s) 1310, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1300 also may comprise one or more input devices 1320, which may comprise without limitation a mouse, a keyboard, a camera, a microphone, and/or the like; and one or more output devices 1325, which may comprise without limitation a display device, a printer, and/or the like.

The computer system 1300 may further include (and/or be in communication with) one or more non-transitory storage devices 1315, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1300 may also include a communications subsystem 1330, which may comprise wireless communication technologies managed and controlled by a wireless communication interface 1335, as well as wired technologies (such as Ethernet, coaxial communications, universal serial bus (USB), and the like). The wireless communication interface 1335 may comprise one or more wireless transceivers that may send and receive wireless signals 1337 (e.g., signals according to 5G NR or LTE) via wireless antenna(s) 1336. Thus the communications subsystem 1330 may comprise a modem, a network card (wireless or wired), an infrared communication device, a wireless communication device, and/or a chipset, and/or the like, which may enable the computer system 1300 to communicate on any or all of the communication networks described herein to any device on the respective network, including UE, base stations and/or other transmission reception points (TRPs), satellites, and/or any other electronic devices described herein. Hence, the communications subsystem 1330 may be used to receive and send data as described in the embodiments herein.

In many embodiments, the computer system 1300 will further comprise a working memory 1340, which may comprise a RAM or ROM device, as described above. Software elements, shown as being located within the working memory 1340, may comprise an operating system 1345, device drivers, executable libraries, and/or other code, such as one or more applications 1350, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1315 described above. In some cases, the storage medium might be incorporated within a computer system, such as computer system 1300. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 1300 and/or might take the form of source and/or installable code, which, upon compilation and/or installation on the computer system 1300 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method performed by a user equipment to configure the user equipment for sensing functions, the method comprising transmitting, to a configuring node, capability information comprising a radio frequency (RF) bandwidth supported by the user equipment for sensing functions; receiving, from the configuring node, configuration information comprising a message indicating allocation of a first RF bandwidth part (BWP) to the user equipment by the configuring node; and utilizing the first RF BWP for performing sensing functions.

Clause 2: The method of clause 1, wherein the first RF BWP is larger than a baseband BWP allocated to the user equipment.

Clause 3: The method of clause 2, wherein the baseband BWP is used by the user equipment for communication operations that are based, at least in part, on orthogonal frequency division multiplexing (OFDM) and wherein the sensing functions are based, at least in part, on using frequency modulated continuous wave (FMCW) operations.

Clause 4: The method of any of clauses 1-3, wherein transmitting the capability information to the configuring node is based on a radio resource control protocol.

Clause 5: The method of any of clauses 1-4, wherein the capability information further comprises a first switching time supported by the user equipment for switching between the baseband BWP and the first RF BWP.

Clause 6: The method of clause 5, wherein the capability information further comprises a second switching time supported by the user equipment for switching between the first RF BWP and a second RF BWP.

Clause 7: The method of clause 6, wherein the second switching time is defined, at least in part, on at least one of a first symbol duration in an FMCW format or a first sensing slot in the FMCW format.

Clause 8: The method of clause 2, further comprising utilizing the baseband BWP for performing communication operations concurrently with utilizing the first RF BWP for performing sensing functions.

Clause 9: A method performed by a configuring node to support a user equipment for performing sensing functions, the method comprising receiving, from the user equipment, capability information comprising a radio frequency (RF) bandwidth supported by the user equipment for sensing functions; allocating, to the user equipment, a first RF bandwidth part (BWP) that is based, at least in part, on the RF bandwidth supported by the user equipment for sensing functions; and transmitting, to the user equipment, information about the first RF BWP allocated to the user equipment.

Clause 10: The method of clause 9, wherein the first RF BWP is larger than a baseband BWP allocated to the user equipment.

Clause 11: The method of clause 10, wherein the baseband BWP is used for communication operations that are based, at least in part, on orthogonal frequency division multiplexing (OFDM) and wherein the sensing functions are based, at least in part, on using frequency modulated continuous wave (FMCW) operations.

Clause 12: The method of any of clauses 9-11, wherein receiving the capability information from the user equipment is based on a radio resource control protocol.

Clause 13: The method of any of clauses 10-12, wherein the capability information further comprises a first switching time supported by the user equipment for switching between the baseband BWP and the first RF BWP.

Clause 14: The method of clause 13, wherein the capability information further comprises a second switching time supported by the user equipment for switching between the first RF BWP and a second RF BWP.

Clause 15: The method of clause 14, wherein the second switching time is defined, at least in part, on at least one of a first symbol duration in an FMCW format or a first sensing slot in the FMCW format.

Clause 16: The method of claim 9, wherein the information transmitted to the user equipment about the first RF BWP comprises a message formatted in a radio resource control protocol.

Clause 17: A user equipment that performs sensing functions, comprising at least one memory and one or more processors communicatively coupled with the at least one memory. The one or more processors are configured to transmit, to a configuring node, capability information comprising a radio frequency (RF) bandwidth supported by the user equipment for sensing functions; receive, from the configuring node, configuration information comprising a message indicating allocation of a first RF bandwidth part (BWP) to the user equipment by the configuring node; and utilize the first RF BWP for performing sensing functions.

Clause 18: The user equipment of clause 17, wherein the configuring node is one of a base station of a cellular network or a server of the cellular network and wherein the first RF BWP is larger than a baseband BWP allocated to the user equipment.

Clause 19: The user equipment of clause 18, wherein the baseband BWP is used for communication operations that are based, at least in part, on orthogonal frequency division multiplexing (OFDM) and wherein the sensing functions are based, at least in part, on using frequency modulated continuous wave (FMCW) operations.

Clause 20: The user equipment of any of clauses 17-19, wherein the capability information transmitted to the configuring node is based on a radio resource control protocol.

Clause 21: The user equipment of any of clauses 17-20, wherein the capability information further comprises a first switching time supported by the user equipment for switching between the baseband BWP and the first RF BWP.

Clause 22: The user equipment of clause 21, wherein the capability information further comprises a second switching time supported by the user equipment for switching between the first RF BWP and a second RF BWP.

Clause 23: The user equipment of clause 22, wherein the second switching time is defined, at least in part, on at least one of a first symbol duration in an FMCW format or a first sensing slot in the FMCW format.

Clause 24: A configuring node that supports a user equipment for performing sensing functions, comprising at least one memory and one or more processors communicatively coupled with the at least one memory. The one or more processors are configured to receive, from the user equipment, capability information comprising a radio frequency (RF) bandwidth supported by the user equipment for sensing functions; allocate, to the user equipment, a first RF bandwidth part (BWP) that is based, at least in part, on the RF bandwidth supported by the user equipment for sensing functions; and transmit, to the user equipment, information about the first RF BWP allocated to the user equipment.

Clause 25: The configuring node of clause 24, wherein the configuring node is one of a base station of a cellular network or a server of the cellular network, and wherein the first RF BWP is larger than a baseband BWP allocated to the user equipment.

Clause 26: The configuring node of clause 24 or 25, wherein the baseband BWP is used for communication operations that are based, at least in part, on orthogonal frequency division multiplexing (OFDM) and wherein the sensing functions are based, at least in part, on using frequency modulated continuous wave (FMCW) operations.

Clause 27: The configuring node of clauses 24-26, wherein the capability information received from the user equipment is based on a radio resource control protocol.

Clause 28: The configuring node of clauses 24-27, wherein the capability information further comprises a first switching time supported by the user equipment for switching between the baseband BWP and the first RF BWP.

Clause 29: The configuring node of clause 28, wherein the capability information further comprises a second switching time supported by the user equipment for switching between the first RF BWP and a second RF BWP.

Clause 30: The configuring node of clause 29, wherein the second switching time is defined, at least in part, on at least one of a first symbol duration in an FMCW format or a first sensing slot in the FMCW format.

Clause 31: An apparatus having means for performing the method of any of clauses 1-8.

Clause 32: An apparatus having means for performing the method of any of clauses 9-16.

Clause 33: A non-transitory computer-readable medium storing instructions, the instructions comprising code for performing the method of any of clauses 1-8.

Clause 34: A non-transitory computer-readable medium storing instructions, the instructions comprising code for performing the method of any of clauses 9-16.

What is claimed is:

1. A method performed by a user equipment to configure the user equipment for sensing functions, the method comprising:
transmitting, to a configuring node, capability information comprising a radio frequency (RF) bandwidth supported by the user equipment for sensing functions;
receiving, from the configuring node, configuration information comprising a message indicating allocation of a first RF bandwidth part (BWP) to the user equipment by the configuring node; and
utilizing the first RF BWP for performing sensing functions.

2. The method of claim 1, wherein the first RF BWP is larger than a baseband BWP allocated to the user equipment for communication operations.

3. The method of claim 2, wherein the baseband BWP is used by the user equipment for communication operations that are based, at least in part, on orthogonal frequency division multiplexing (OFDM) and wherein the sensing functions are based, at least in part, on using frequency modulated continuous wave (FMCW) operations.

4. The method of claim 3, wherein transmitting the capability information to the configuring node is based on a radio resource control protocol.

5. The method of claim 2, wherein the capability information further comprises a first switching time supported by the user equipment for switching between the baseband BWP and the first RF BWP.

6. The method of claim 5, wherein the capability information further comprises a second switching time supported by the user equipment for switching between the first RF BWP and a second RF BWP.

7. The method of claim 6, wherein the second switching time is defined, at least in part, on at least one of a first symbol duration in an FMCW format or a first sensing slot in the FMCW format.

8. The method of claim 2, further comprising:
utilizing the baseband BWP for performing communication operations concurrently with utilizing the first RF BWP for performing sensing functions.

9. A method performed by a configuring node to support a user equipment for performing sensing functions, the method comprising:
receiving, from the user equipment, capability information comprising a radio frequency (RF) bandwidth supported by the user equipment for sensing functions;
allocating, to the user equipment, a first RF bandwidth part (BWP) that is based, at least in part, on the RF bandwidth supported by the user equipment for sensing functions; and
transmitting, to the user equipment, information about the first RF BWP allocated to the user equipment.

10. The method of claim 9, wherein the first RF BWP is larger than a baseband BWP allocated to the user equipment for communication purposes.

11. The method of claim 10, wherein the baseband BWP is used for communication operations that are based, at least in part, on orthogonal frequency division multiplexing (OFDM) and wherein the sensing functions are based, at least in part, on using frequency modulated continuous wave (FMCW) operations.

12. The method of claim 11, wherein receiving the capability information from the user equipment is based on a radio resource control protocol.

13. The method of claim 10, wherein the capability information further comprises a first switching time supported by the user equipment for switching between the baseband BWP and the first RF BWP.

14. The method of claim 13, wherein the capability information further comprises a second switching time supported by the user equipment for switching between the first RF BWP and a second RF BWP.

15. The method of claim 14, wherein the second switching time is defined, at least in part, on at least one of a first symbol duration in an FMCW format or a first sensing slot in the FMCW format.

16. The method of claim 9, wherein the information transmitted to the user equipment about the first RF BWP comprises a message formatted in a radio resource control protocol.

17. A user equipment that performs sensing functions, comprising:
at least one memory; and
one or more processors communicatively coupled with the at least one memory, the one or more processors configured to:
transmit, to a configuring node, capability information comprising a radio frequency (RF) bandwidth supported by the user equipment for sensing functions;
receive, from the configuring node, configuration information comprising a message indicating allocation of a first RF bandwidth part (BWP) to the user equipment by the configuring node; and
utilize the first RF BWP for performing sensing functions.

18. The user equipment of claim 17, wherein the configuring node is one of a base station of a cellular network or a server of the cellular network and wherein the first RF BWP is larger than a baseband BWP allocated to the user equipment.

19. The user equipment of claim 18, wherein the baseband BWP is used by the user equipment for communication operations that are based, at least in part, on orthogonal frequency division multiplexing (OFDM) and wherein the sensing functions are based, at least in part, on using frequency modulated continuous wave (FMCW) operations.

20. The user equipment of claim 19, wherein the capability information transmitted to the configuring node is based on a radio resource control protocol.

21. The user equipment of claim 18, wherein the capability information further comprises a first switching time supported by the user equipment for switching between the baseband BWP and the first RF BWP.

22. The user equipment of claim 21, wherein the capability information further comprises a second switching time supported by the user equipment for switching between the first RF BWP and a second RF BWP.

23. The user equipment of claim 22, wherein the second switching time is defined, at least in part, on at least one of a first symbol duration in an FMCW format or a first sensing slot in the FMCW format.

24. A configuring node that supports a user equipment for performing sensing functions, comprising:
at least one memory; and
one or more processors communicatively coupled with the at least one memory, the one or more processors configured to:
receive, from the user equipment, capability information comprising a radio frequency (RF) bandwidth supported by the user equipment for sensing functions;
allocate, to the user equipment, a first RF bandwidth part (BWP) that is based, at least in part, on the RF bandwidth supported by the user equipment for sensing functions; and
transmit, to the user equipment, information about the first RF BWP allocated to the user equipment.

25. The configuring node of claim 24, wherein the configuring node is one of a base station of a cellular network or a server of the cellular network, and wherein the first RF BWP is larger than a baseband BWP allocated to the user equipment.

26. The configuring node of claim 25, wherein the baseband BWP is used by the user equipment for communication operations that are based, at least in part, on orthogonal frequency division multiplexing (OFDM) and wherein the sensing functions are based, at least in part, on using frequency modulated continuous wave (FMCW) operations.

27. The configuring node of claim 26, wherein the capability information received from the user equipment is based on a radio resource control protocol.

28. The configuring node of claim 25, wherein the capability information further comprises a first switching time supported by the user equipment for switching between the baseband BWP and the first RF BWP.

29. The configuring node of claim 28, wherein the capability information further comprises a second switching time supported by the user equipment for switching between the first RF BWP and a second RF BWP.

30. The configuring node of claim 29, wherein the second switching time is defined, at least in part, on at least one of a first symbol duration in an FMCW format or a first sensing slot in the FMCW format.
